(19) United States
(12) Patent Application Publication
(10) Pub. No.: US 2024/0203225 A1
(43) Pub. Date: Jun. 20, 2024

(54) SYSTEM FOR AN AUTOMATED INVENTORY AND ASSOCIATED REMOVABLE ELECTRONIC ANTI-THEFT

(71) Applicant: EXAQTWORLD, PARIS (FR)

(72) Inventor: Antoine LELOUP, PARIS (FR)

(21) Appl. No.: 18/287,077

(22) PCT Filed: Apr. 15, 2022
(86) PCT No.: PCT/FR2022/050721

§ 371 Date: Oct. 16, 2023

(30) Foreign Application Priority Data
Apr. 19, 2021 (FR) FR21 04061

(51) Int. Cl. G08B 13/24

(52) U.S. Cl. CPC G08B 13/2462

(57) ABSTRACT

A removable electronic anti-theft device (4) and associated inventory system, the device comprising a passive detection means (20), a removable attachment means (11) capable of occupying two states in which said attachment means is respectively locked on an article (A1) to be secured or detached from said article, a memory (23) capable of containing at least one item of information, an energy source (22), a state sensor (19) of the device, which is capable of indicating a charge level of the energy source and/or a state of the attachment means, and a wireless control and communication unit (21) capable of transmitting a signal comprising an item of state information provided by the state sensor and an item of information relating to the article, such that a control means of the energy source permits switching the energy source between 3 modes: off, standby or active, according to an item of state information received from the state sensor.

The present invention relates to a system for an automated inventory and an associated removable antitheft electronic device. The invention is of particular benefit for the implementation of an automated inventory in premises containing a very large number of articles, each provided with a removable antitheft electronic device, disposed on sales counters, or even storage rooms.

Generally, the term antitheft electronic device designates an electronic system intended to warn of and prevent a theft. It comprises a badge or tag fixed to a commercial article to be protected. This badge is inseparable from the article to be protected in order to be able to reuse it, and thus allow it to be fixed onto a new article to be protected after the first article on which it was mounted has been sold. The use of these antitheft devices is necessary in the places where articles to be protected are stored and presented for sale. When the articles to be protected are presented for sale in a place, often a store, a consumer can take hold of it and it is customary practice for the consumer to duly pay for it at a till where the antitheft device will be removed.

A forgetful consumer who might leave a place of sale with an article still provided with an associated antitheft device would provoke the emission of a signal at an exit from the place of sale. The effectiveness of these antitheft devices lies on the one hand in the difficulty of detaching them from the article to be protected and on their capacity to generate an alarm when an active badge, which has not previously been removed at the till, crosses the exit, or there is an attempt to detach the badge.

These passive antitheft devices are of no use in the case of article stock inventories. Even though antitheft badges are known which contain information relating to the article, as is described in the document FR-2 990 978, the reading of these antitheft badges necessitates going through the till and the opening of the badge, with the badge deactivated, to allow the indications contained on the one hand on a price tag corresponding to a given product fixed to the article and on the other hand an optical read datum contained in the badge concerning the precise article to which it is fixed to be checked and crossed. To perform fair inventories, independent of the tags which may just have been torn away, damaged or altered, it is then necessary to open each badge in succession to read the information linked to each of the articles to be protected, and to mount the badge back on the article, before being able to inventory a next article. This solution, although of interest for avoiding sale price errors, is not appropriate for inventories.

Antitheft tags equipped with so-called passive UHF RFID technology chips are also known, which make it possible to take inventories in a store, when a mobile RFID reader embedding a software solution capable of detecting an electromagnetic field produced by said RFID chip, also capable of counting the number of chips detected, is moved around in the various departments of the store. To allow for a differentiated detection of each article to be protected, it is necessary to first proceed with an operation of encoding the RFID antitheft tag with data relating to the article to be protected with which it is associated. These data will then be able to be read when inventorying articles theft-protected by the RFID reader.

This inventory operation therefore necessitates a human intervention with a complete or partial scan of the sales surface area and/or of the reserve with a reader for reading the articles, which, although faster compared to a traditional inventory with barcodes, can nevertheless seem tedious if the surface area of the store is great and may show up a few omissions for want of not having passed through all the zones, or of not counting all the articles when there are too many tags juxtaposed. Furthermore, the stock of the store can be considered to be up-to-date only if the inventories are taken fairly close together in time. It should be stressed that the managers of stores need the most recent possible stock information to better control their sales businesses and restocking from the warehouse.

There is therefore a need to facilitate the taking of inventories, and to have a better knowledge in real-time of the stocks of protected articles available for sale. The invention sets out to find a solution to this problem, notably by proposing an automated inventory solution, without human intervention, and without necessary movement around the departments of the store, while guaranteeing the possibility of regular inventories over a long period of time. The benefit of the invention is that of making it possible to secure and inventory articles for which the sale times may be very long, and with holding times in a department of several months or years, but also that of being able to increase the operability of the antitheft devices before the latter need to be repaired, even when they are used iteratively on successive articles to be protected.

The subject of the invention is a system for an automated inventory of several articles to be secured disposed in a business premises, each article being equipped with a removable antitheft electronic device, the system comprising a detector at an exit from the business premises and a beacon disposed in the business premises, each beacon being provided with a wireless communication means, the antitheft electronic device optionally comprising a detection means capable of being detected by the detector of the business premises, and further comprising
an energy source, notably this source can be a battery or an accumulator,
a memory capable of containing at least one information item relating to the article,
a removable fixing means capable of occupying two states relative to the article, a first state in which it is locked and not manually removable from the article and a state in which it is detached from the article,
a state sensor of the antitheft electronic device, this state sensor being able to indicate a level of charge of the energy source and/or a state of the fixing means,
a wireless control and communication unit capable of emitting a signal comprising an information item relating to the article, this signal being intended to be read by the beacon,
the device comprising a means for controlling the energy source, this control means making it possible to switch the energy source between three modes: off, on standby or active based on a state information item from the state sensor and an inventory frequency setpoint contained in the memory.

The benefit of the invention is that of allowing the activation, called switching of the energy source to active mode, at the moment when the fixing means is brought into a locked state relative to an article, and thus allowing an encoding of data relating to this article in the memory. This optimization of the energy consumption enhances the period of use of the device and the possibility of implementing the automated inventory system.

In particular, the wireless control and communication unit can comprise a near field communication chip in a body and/or an end of the removable fixing means, the insertion of the end into a housing of the body bringing the fixing means into a locked state. Alternatively, the locked state of the fixing means can be obtained with an antitheft device of clamp type formed from a single body or of pin type, and in this case, the wireless control and communication unit is housed in this single body.

The wireless control and communication unit can also be capable of emitting a signal comprising a state information item supplied by the state sensor. The system according to the invention can thus monitor a change of state from locked to detached that is untimely and synonymous with burglary, just as it can also detect a lowering of the level of the energy source and therefore of the faculty of the device to allow said inventories.

Advantageously, the system can comprise a software platform for receiving the data collected by the beacon and programming a frequency, a duration and/or a zoning of the reads performed by the beacon.

To optimize the use of the energy necessary for the operation of the system, the wireless control and communication unit can vary its emission power as a function of a distance detected between the device and the beacon. In the case where the business premises comprise several beacons, the wireless control and communication unit can comprise a means for detecting the nearest beacon, in order to minimize the emission power. Thus, the tighter the beacons are meshed over the sales surface area, the more the emission power of the wireless control and communication units will be able to be reduced, and thus the lifetime of the device can be increased, and the need to change, renew or recharge the energy source thereof can be limited.

Preferentially, antitheft devices according to the invention retained on articles to be secured can each comprise a clock programmed to limit the number of energy source control means switching to active status during a same time period. One advantage of this provision is to limit the number of signals emitted simultaneously, respectively by the different wireless control and communication units of the different devices. Preferably, the energy source can be recharged, and thus prolong the period of operation of the antitheft device.

In a particular embodiment of the invention, a control means of the energy source can comprise an accelerometer in order to switch the energy source into the active mode when the value measured by the accelerometer exceeds a threshold. Thus, the detection of said device by the beacons and/or the reader disposed at the exit from the business premises makes it possible to anticipate fraudulent removals of the articles. Alternatively, to switch the energy source to active mode, the control means of the energy source can comprise a motion and/or vibration detector.

Also a subject of the invention is a removable antitheft electronic device optionally comprising a detection means capable of being detected by a detector of a business premises, and further comprising
an energy source,
a memory capable of containing at least one information item,
a removable fixing means capable of occupying two states relative to an article to be secured, a first state in which it is locked and not manually removable from the article and a state in which it is detached from the article,
a state sensor of the antitheft electronic device, this state sensor being able to indicate a level of charge of the energy source and/or a state of the fixing means,
a wireless control and communication unit capable of emitting a signal comprising a state information item supplied by the state sensor and an information item relating to the article,
the device comprising a control means of the energy source control means, this control means making it possible to switch the energy source between three modes: off, on standby or active based on a state information item from the state sensor.

Advantageously, the control means of the energy source can operate according to an inventory frequency setpoint contained in the memory, the wireless control and communication unit being capable of emitting a signal comprising an information item relating to the article to be secured.

Preferentially, the detection means can be distinct from the wireless control and communication unit, and be passive. For example, this detection means can be of radio-frequency (8.2 MHz standardized RF) or acousto-magnetic type.

For an optimized operation of the device, the wireless control and communication unit can emit a signal when the energy source is active.

For an acceptable distance between the device and the beacon, and in order to limit the number of beacons that are necessary in a business premises, the wireless control and communication unit can operate according to the Bluetooth Low Energy (BLE) protocol. In particular, this unit can communicate actively and bidirectionally at a frequency of 2.4 GHZ.

In particular, the state information item can relate to the current locked or detached state of the fixing means, and/or relate to a number of changes of state of said fixing means since its initialization up to the date of emission of the information item. Thus, since a change of state can be a sign of a burglary, it is possible to detect devices in detached position which should not be so, and/or devices that are locked and likely detached from any article. It is thus possible to count, during an inventory, the stolen articles by counting the number of devices that are active and which are no longer linked to an article. This information item makes it possible also to take an inventory of the number of antitheft devices available in the store to secure other articles.

Indeed, the invention relates also to the assembly formed by an article to be secured and an antitheft device according to the invention retained on this article, in which the control means of the energy source can make it possible to switch the mode of the energy source based on an inventory frequency setpoint contained in the memory of the device, this inventory frequency being a function of a threshold relating to a quality of said article, for example its market value.

The invention also targets a method for associating an article to be secured and a removable antitheft device according to the invention comprising the following successive steps:
a fixing means of the device is brought into a state in which it is locked and retained so as to be not manually removable on the article,
the control means of the energy source switches the energy source to active mode for a time t, the start of which begins at the end of the preceding step,
during this time t, an information item relating to the article is entered in the memory,
after this time t, the energy source is switched to standby mode.

Conversely, the device being re-usable, also a subject of the invention is a method for dissociating an article to be secured and a removable antitheft device retained so as to be not manually removable on this article, the device being according to the invention, and the disassociation method comprising the following successive steps:
freeing of the fixing means from the device to bring it into a detached state using an external tool,
the control means of the energy source switches the energy source to active mode for a time t, the start of which begins at the end of the preceding step,
during this time t, the wireless control and communication unit emits a signal comprising an information item relating to the article and to an identifier of the device, notably in order to allow these data that are then collected by the beacon to be able to allow a dissociation of these two information items in the software platform,
after this time t, the energy source is switched to off or standby mode.

This dissociation method makes it possible to check the data collected for an inventory. Indeed, the inventory can thus be constructed in a subtractive manner with reference to a known situation, from which the dissociated articles are removed. Or, alternatively, the inventory can be designed to be additive, by counting only the articles associated with a device.

This dissociation method can also be effective for allowing an article to be protected to be billed and sold at the right price. Indeed, in addition to the price tag of the article, the device can thus allow for an additional check of the sales receipts.

### BRIEF DESCRIPTION OF THE DRAWINGS

The attached drawings illustrate the invention:

FIG. 1 represents a schematic view of the elements of a system according to the invention;

FIG. 2 represents a schematic cross-sectional view of a first embodiment of a device according to the invention;

FIG. 3 represents a schematic cross-sectional view of a second embodiment of a device according to the invention.

### DESCRIPTION OF EMBODIMENTS

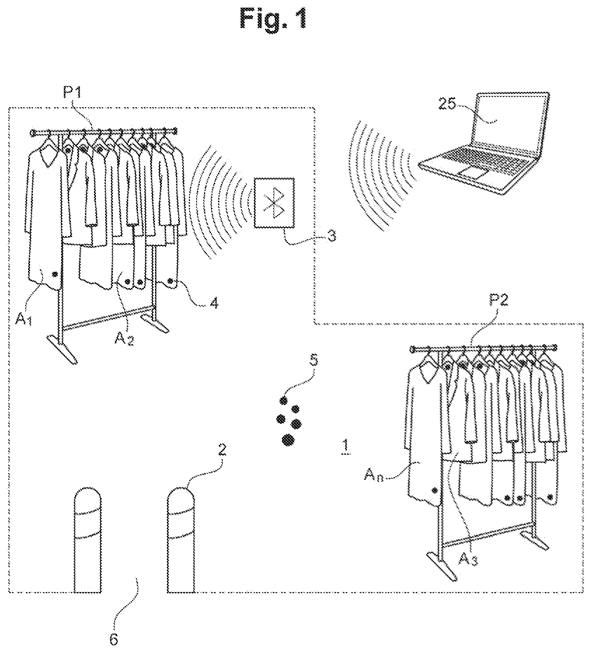

FIG. 1 represents a business premises 1 in which an inventory system according to the invention is installed. The system according to the invention is particularly suited to closed commercial premises, with a ground surface area of between 5 and 500 m². The system makes it possible to take an inventory of several distinct articles A1, A2, A3, An . . . disposed in these business premises 1. The system according to the invention is particularly effective for inventorying premises containing up to several thousands of distinct articles. The articles can be disposed in different points of the business premises, the articles being able to be spaced apart by several tens of meters, or be adjacent by a few millimeters.

The system comprises a detector 2 disposed at a passageway 6, allowing people or machines to enter and/or exit from said business premises. Preferably, if the business premises comprise several passageways, then the system comprises detectors such as 2 at each of these exits.

The system also comprises a beacon 3 for detecting at least one antitheft device 4. The antitheft device can be secured to an article as is the case in the example represented for the articles A1, A2 and A3, where each of these articles is provided with an antitheft device such as 4. The beacon 3 can also detect a batch 5 of antitheft devices not secured to an article.

In particular, in the example represented, there are in the business premises different antitheft devices 4, those that are retained locked on articles to be protected on a first rail P1, those retained on a second rail P2, in another zone of the business premises, and the batch 5 of devices available for subsequent use. The antitheft devices are electronic devices, they are removable, such that they can be fixed to and detached from an article to be secured and/or to be inventoried. The articles A1, A2, A3, An . . . of the business premises 1, when they are respectively provided with an antitheft device such as 4, are secured because the device 4 comprises a detection means capable of being detected by the detector 2 when the exit passageway is crossed. These articles are also capable of being inventoried. In the case where the antitheft device does not comprise any detector, the detection of frauds when the exit passageways are crossed can also be obtained by virtue of the beacon 3.

The beacon 3 is fixed in the business premises, the detector 2 is, here, distinct from the beacon. The beacon can be supported by a same portal in which the detector is also disposed.

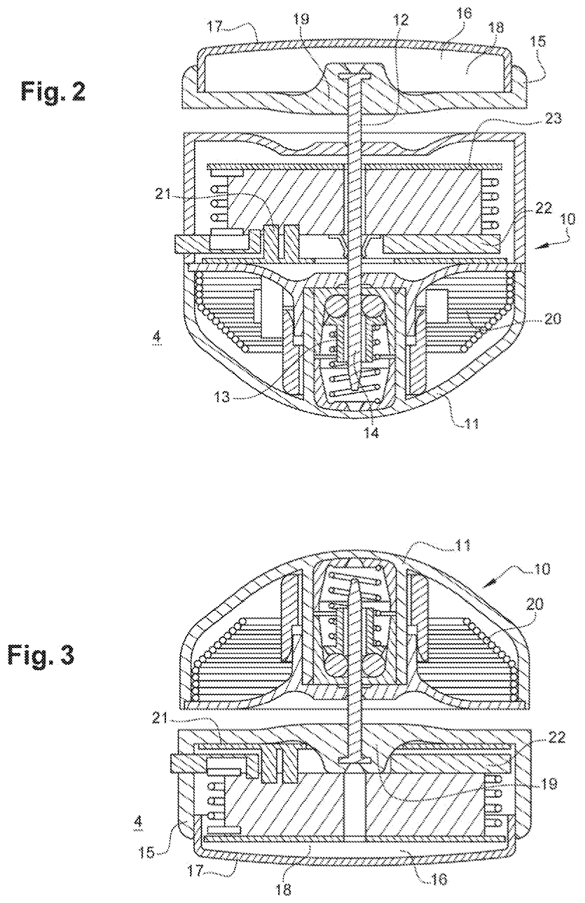

In particular, the antitheft device 4 comprises a body 10 and a removable fixing means 11. The removable closure can be obtained mechanically or magnetically, for example with a nail 12 intended to be inserted through the article and of which one end 13 of this nail is retained in the body 10 of the device as represented in the embodiments of FIGS. 2 and 3; or even by a clamp, the two ends of which can be closed so as to clamp the article.

In the example represented in FIG. 2, the removable fixing means comprising the end 13 is retained in a housing 14 of the body 10. One head of this nail 12 comprises a plate 15. As a variant, the nail 10 can be replaced by a flexible cable, one end of which is secured to the body 10 and the other end of which is mounted so as to be able to be retained removably in the housing 14.

The plate 15 can delimit a volume 16 with a transparent window 17 to retain a document 18 therein, such as a customizing paper token, notably relating to the brand of an article to be secured and/or inventoried.

The device 4 comprises a means 19 for detecting engagement of this end 13 in the body 10. This detection means 19 is a state sensor of the device, making it possible to detect if the device 4 is in locked position such that the nail 12 is not manually removable from the body 10, or else in detached position, in which the nail 12 can be manually detached from the body 10, and at the very least the end 13 of the nail is not received in the housing 14.

The device comprises a detection means 20 capable of being detected by the detector 2, such that this detection means is detectable when the device is in locked position, but also when the device has been opened without authorization or if the nail 12 has been vandalized.

The device according to the invention also comprises a wireless control and communication unit 21 powered by an energy source 22. The detection means 19 is also capable of detecting the state, and at least detecting a minimum charge threshold of the energy source 22. The wireless control and communication unit 21 preferably communicates according to the Bluetooth technology. It makes it possible to emit a signal comprising information coded in a memory 23, and also information originating from the detection means 19 concerning detected states of the device.

According to the embodiment of FIG. 2, the wireless control and communication unit 21, the energy source 22, the detection means 19 and the memory 23 are disposed in the body 10. Alternatively, according to the embodiment of FIG. 3, they are disposed in the volume 16 of the plate 15.

The wireless control and communication unit 21 comprises an antenna capable of communicating with the beacon 3. The system according to the invention comprises a control means of the energy source 22, this control means making it possible to switch the energy source between three modes: off, on standby or active according to a state information item from the state sensor 19 and an inventory frequency setpoint contained in the memory 23. This control means can be disposed in a central computer 25 communicating with the beacon 3. Alternatively, this control means can be contained in the antitheft device 4. The computer 25 forms a software platform 25 for receiving the data collected by the beacon 3 and possibly programming a frequency, a duration and/or a zoning of the reads performed by the beacon.

The normal opening of the antitheft device provides for the use of an external tool, for example, a magnet, to bring the fixing means 11 into a detached state.

1. A system for an automated inventory of several articles to be secured disposed in a business premises, each article being equipped with a removable antitheft electronic device, the system comprising:
a detector at an exit of the business premises and a beacon disposed in the business premises, this beacon being provided with a wireless communication means, the antitheft electronic device comprising
an energy source,
a memory capable of containing at least one information item relating to the article,
a removable fixing means capable of occupying two states relative to the article, a first state in which it is locked and not manually removable from the article and a state in which it is detached from the article,
a state sensor of the antitheft electronic device, this state sensor indicating a level of charge of the energy source, and/or a state of the fixing means,
a wireless control and communication unit capable of emitting a signal comprising an information item relating to the article, this signal being intended to be read by the beacon,
wherein said antitheft electronic device comprises a control means of the energy source, this control means making it possible to switch the energy source between three modes: off, on standby or active based on a state information item from the state sensor and an inventory frequency setpoint contained in the memory.

2. The system as claimed in claim 1, wherein the wireless control and communication unit is capable of emitting a signal comprising a state information item supplied by the state sensor.

3. The system as claimed in claim 1, it wherein said system comprises a software platform for receiving the data collected by the beacon and programming a frequency, a duration and/or a zoning of the reads of the beacon.

4. The system as claimed in claim 1, characterized in that wherein an emission power of the wireless control and communication unit is a function of a distance detected between the device and the beacon.

5. The system as claimed in claim 1, characterized in that wherein the antitheft devices retained on the articles to be secured each comprise a clock programmed to limit the number of control means of the energy source switching to active status for a same time period.

6. The system as claimed in claim 1, characterized in that wherein a control means of the energy source comprises an accelerometer, a motion detector and/or a vibration detector in order to switch the energy source into the active mode when a value measured by the accelerometer exceeds a threshold.

7. A removable antitheft electronic device comprising
an energy source,
a memory capable of containing at least one information item,
a removable fixing means capable of occupying two states relative to an article to be secured, a first state in which it is locked and cannot be manually removed from the article and a state in which it is detached from the article,
a state sensor of the antitheft electronic device, this state sensor being able to indicate a level of charge of the energy source and/or a state of the fixing means,
a wireless control and communication unit capable of emitting a signal comprising a state information item supplied by the state sensor and an information item relating to the article,
wherein said removable antitheft electronic device further comprises a control means of the energy source, this control means making it possible to switch the energy source between three modes: off, on standby or active based on a state information item from the state sensor.

8. The removable antitheft electronic device as claimed in claim 7, wherein the control means of the energy source operates according to an inventory frequency setpoint contained in the memory, and in that the wireless control and communication unit is capable of emitting a signal comprising an information item relating to the article to be secured.

9. The removable antitheft electronic device as claimed in claim 7, wherein said removable antitheft electronic device further comprises a detection means (20) capable of being detected by a detector of a business premises, the detection means being, for example, passive, notably of radiofrequency or acousto-magnetic type.

10. The removable antitheft electronic device as claimed in claim 7, wherein the wireless control and communication unit is powered by the energy source.

11. The removable antitheft electronic device as claimed claim 10, wherein the wireless control and communication unit operates according to the Bluetooth Low Energy (BLE) protocol.

12. The removable antitheft electronic device as claimed in claim 7, wherein the state information item relates to the current locked or detached state of the fixing means, and/or the number of changes of state of said fixing means since its initialization up to the date of emission of the information item.

13. An assembly formed by an article to be secured and a removable antitheft electronic device retained on this article, the removable antitheft electronic device as claimed in claim 7, the control means of the energy source making it possible to switch the mode of the energy source as a function of an inventory frequency setpoint contained in the memory of the device, the inventory frequency being a function of a threshold relating to a quality of said article.

14. A method for associating an article to be secured and a removable antitheft device as claimed in claim 7, said method comprising the following steps:
a fixing means of the device is brought into a locked state and retained in a way that cannot be removed manually on the article,
the control means of the energy source switches the energy source to active mode for a time t, the start of which begins at the end of the preceding step,
during this time t, an information item relating to the article is entered into the memory,
after this time t, the energy source is switched to standby mode.

15. A method for dissociating an article to be secured and a removable antitheft device retained in a way that cannot be removed manually on this article, the device being as claimed in claim 7, wherein said method comprises the following steps:
freeing of the fixing means from the device to bring it into a detached state using an external tool,
the control means of the energy source switches the energy source to active mode for a time t, the start of which begins at the end of the preceding step,
during this time t, the wireless control and communication unit emits a signal comprising an information item relating to the article and to an identifier of the device,
after this time t, the energy source is switched to off or standby mode.
